(19) United States
(12) Patent Application Publication
(10) Pub. No.: US 2026/0192545 A1
(43) Pub. Date: Jul. 9, 2026

(54) GRAPHITE COMPOSITE AND METHOD FOR PRODUCING GRAPHITE COMPOSITE

(71) Applicant: KANEKA CORPORATION, Osaka (JP)

(72) Inventors: Takeshi NAKAGAKI, Tokyo (JP); Motoaki KOBAYASHI, Settsu-shi, Osaka (JP)

(73) Assignee: KANEKA CORPORATION, Osaka (JP)

(21) Appl. No.: 19/131,925

(22) PCT Filed: Nov. 20, 2023
(86) PCT No.: PCT/JP2023/041564

§ 371 Date: May 21, 2025

(30) Foreign Application Priority Data
Nov. 24, 2002 (JP) 2022-187656

(51) Int. Cl. B32B 9/00; B32B 7/12; B32B 9/04; B32B 15/20; B32B 37/24; B32B 38/00; B32B 43/00

(52) U.S. Cl. CPC B32B 9/007; B32B 7/12; B32B 9/041; B32B 9/045; B32B 15/20; B32B 37/24; B32B 38/0004; B32B 43/003; B32B 2037/243; B32B 2250/05; B32B 2250/40; B32B 2255/205; B32B 2307/302; B32B 2307/706; B32B 2307/72; B32B 2307/7376; B32B 2311/04; B32B 2311/12; B32B 2311/22

(57) ABSTRACT

An object of the present invention is to achieve a graphite composite excellent in thermal diffusion ability with an anisotropic graphite laminate having reduced susceptibility to cracking. The object can be accomplished with a graphite composite including: an anisotropic graphite laminate in which, in XYZ space, two or more graphite sheets are stacked on top of each other, in the Y axis direction, with a resin layer between adjacent graphite sheets, and crystal orientation planes of graphite layers are disposed in parallel to the X-Z plane, wherein the anisotropic graphite laminate has a first principal face and a second principal face each parallel to the X-Y plane; a first metal layer on the first principal face; a second metal layer on the second principal face; and a reinforcing layer parallel to the Y-Z plane, wherein the first metal layer and the second metal layer each have a thickness of 2 μm to 50 μm.

### TECHNICAL FIELD

The present invention relates to a graphite composite and a method for producing a graphite composite.

### BACKGROUND ART

Graphite is widely used as an element for transferring and dissipating heat generated from electronic equipment and devices.

In particular, anisotropic graphite that includes graphite structures in each of which six-membered rings of carbon atoms are linked together by covalent bonds and which are joined by Van der Waals forces has high thermal conductivity. Accordingly, anisotropic graphite has been attracting attention as an element for effectively transferring and dissipating heat generated from electronic equipment and devices.

For example, Patent Literature 1 discloses anisotropic graphite and an anisotropic graphite composite, each having excellent heat transmission performance and long-term reliability as a heat-transmitting element, and a method for producing the same. In the technique described in Patent Literature 1, a titanium-containing metal layer, an inorganic material layer, etc., are formed on a principal face of the anisotropic graphite.

### CITATION LIST

### Patent Literature

Patent Literature 1: WO 2019/188915 A1

### SUMMARY OF INVENTION

### Technical Problem

Conventional techniques as described above are sophisticated. On the other hand, in the case of using, as anisotropic graphite, an anisotropic graphite laminate in which two or more sheets of anisotropic graphite are stacked on top of each other with a resin layer between adjacent graphite sheets, there has been room for achieving improvement in thermal diffusion ability and reduction in susceptibility of the anisotropic graphite laminate to cracking in combination.

An object of an aspect of the present invention is to achieve a graphite composite excellent in thermal diffusion ability with an anisotropic graphite laminate having reduced susceptibility to cracking.

### Solution to Problem

To solve the problem, a graphite composite according to an embodiment of the present invention has the following configuration.

A graphite composite including:
an anisotropic graphite laminate in which, given an X axis, a Y axis orthogonal to the X axis, and a Z axis perpendicular to the X-Y plane as three spatial axes orthogonal to each other, two or more graphite sheets are stacked on top of each other, in the Y axis direction, with a resin layer between adjacent graphite sheets, and crystal orientation planes of graphite layers are disposed in parallel to the X-Z plane, wherein the anisotropic graphite laminate has a first principal face parallel to the X-Y plane and a second principal face opposite to the first principal face;
a first metal layer provided on the first principal face of the anisotropic graphite laminate;
a second metal layer provided on the second principal face of the anisotropic graphite laminate; and
a reinforcing layer provided on at least one of two surfaces of the anisotropic graphite laminate that are parallel to the Y-Z plane, wherein
the first metal layer and the second metal layer each have a thickness of 2 μm to 50 μm.

To solve the problem, a method for producing a graphite composite according to an embodiment of the present invention has the following configuration.

A method for producing a graphite composite including an anisotropic graphite laminate in which, given an X axis, a Y axis orthogonal to the X axis, and a Z axis perpendicular to the X-Y plane as three spatial axes orthogonal to each other, two or more graphite sheets are stacked on top of each other, in the Y axis direction, with a resin layer between adjacent graphite sheets, and crystal orientation planes of graphite layers are disposed in parallel to the X-Z plane, wherein the anisotropic graphite laminate has a first principal face parallel to the X-Y plane and a second principal face opposite to the first principal face, the method including:
a reinforcing step of forming a reinforcing layer on at least one of two surfaces of the anisotropic graphite laminate that are parallel to the Y-Z plane; and
a metal layer formation step of forming a first metal layer and a second metal layer respectively on the first principal face and second principal face of the anisotropic graphite laminate with the reinforcing layer formed thereon, wherein
the first metal layer and the second metal layer each have a thickness of 2 μm to 50 μm.

### Advantageous Effects of Invention

An aspect of the present invention can provide a graphite composite excellent in thermal diffusion ability with an anisotropic graphite laminate having reduced susceptibility to cracking even in a case where an anisotropic graphite laminate in which two or more sheets of anisotropic graphite are stacked on top of each other with a resin layer between adjacent graphite sheets is used as anisotropic graphite.

### BRIEF DESCRIPTION OF DRAWINGS

FIG. 1 is a diagram illustrating a configuration of a graphite composite according to an embodiment of the present invention.

FIG. 2 is a diagram illustrating steps of a method for producing a graphite composite according to an embodiment of the present invention.

FIG. 3 is a diagram illustrating configurations of a test sample and a testing apparatus that are used for evaluation test on heat transmission performance in Examples of the present invention.

### DESCRIPTION OF EMBODIMENTS

An embodiment of the present invention is described below, but the present invention is not limited thereby. The present invention is not limited to configurations described below, and various modifications within the scope shown in claims are permitted. Embodiments or examples given by combining technical means disclosed in different embodiments or examples are also included in the technical scope of the present invention. Furthermore, a new technical feature can be formed by combining technical means disclosed in different embodiments. All of the academic documents and patent literatures cited herein are incorporated herein as references. Unless otherwise specified, “A to B” showing a numerical range herein means “A or more (including A and being more than A) and B or less (including B and being less than B)”.

### [1. Basic Principle of Present Invention]

As described above, in the technique described in Patent Literature 1, a titanium-containing metal layer and an inorganic material layer, etc., are formed on a principal face of anisotropic graphite. An inorganic material layer formed on a principal face of anisotropic graphite exhibits a tendency to inhibit the excellent thermal diffusion ability of anisotropic graphite. In addition, anisotropic graphite has a character of susceptibility to cracking along crystal orientation planes of graphite layers. The mentioned tendency of the inorganic material layer to inhibit the thermal diffusion ability and the mentioned character of susceptibility to cracking along the crystal orientation planes also arise in using, as the anisotropic graphite, an anisotropic graphite laminate in which two or more sheets of anisotropic graphite are stacked on top of each other with a resin layer between adjacent graphite sheets.

Therefore, it is desirable in terms of thermal diffusion ability that a structure to be provided on a principal face of an anisotropic graphite laminate include only a metal layer. Contemplated as a method for forming a metal layer on a principal face of an anisotropic graphite laminate are, for example, a method of directly forming a metal layer on a principal face of an anisotropic graphite laminate by plating or the like, a method of forming a metal layer on a principal face of an anisotropic graphite laminate by interposing a metal layer adhesive containing a metal brazing material, and a method of forming a metal layer on a principal face of an anisotropic graphite laminate by interposing an organic adhesive. Organic adhesives exhibit a tendency to inhibit the excellent thermal diffusion ability of an anisotropic graphite laminate. Accordingly, the method of directly forming a metal layer on an anisotropic graphite laminate by plating or the like, the method of forming a metal layer on a principal face of an anisotropic graphite laminate by interposing a metal layer adhesive containing a metal brazing material, and any like method are more preferable among those. In the case of using, as anisotropic graphite, an anisotropic graphite laminate in which two or more sheets of anisotropic graphite are stacked on top of each other with a resin layer between adjacent graphite sheets, the anisotropic graphite laminate has lower thermal resistance due to the presence of the resin layer than that in the absence of the resin layer. Accordingly, use of a method of forming a metal layer under high-temperature conditions such as the method of forming a metal layer by interposing a metal layer adhesive containing a metal brazing material is unpreferable. Thus, the method of directly forming a metal layer on an anisotropic graphite laminate by plating or the like is even more preferable. However, the method of directly forming a metal layer on an anisotropic graphite laminate by plating or the like gives a thin metal layer. Accordingly, a composite in which a metal layer has been formed on a principal face of an anisotropic graphite laminate by plating or the like cannot ensure sufficient strength of the metal layer, and hence has a problem of susceptibility to cracking along crystal orientation planes of graphite layers.

In view of this, an object of an embodiment of the present invention is to provide a graphite composite excellent in thermal diffusion ability with an anisotropic graphite laminate having reduced susceptibility to cracking even in a case where a laminate in which two or more graphite sheets are stacked on top of each other with a resin layer between adjacent graphite sheets is used as the anisotropic graphite laminate.

The present inventors have found that (i) the susceptibility of an anisotropic graphite laminate to cracking can be reduced with a reinforcing layer disposed in a unique manner, (ii) inclusion of the reinforcing layer allows a structure (e.g., metal layers including a first metal layer and a second metal layer) covering the periphery of the anisotropic graphite laminate to be thin and allows the structure covering the periphery of the anisotropic graphite laminate to be simplified (e.g., the structure to be provided on a principal face of the anisotropic graphite laminate is simplified to include only the first metal layer and the second metal layer), thereby making it possible to impart enhanced thermal diffusion ability to the graphite composite, and (iii) the thin structure (e.g., metal layers including the first metal layer and the second metal layer) covering the periphery of the anisotropic graphite laminate can further reduce the susceptibility of the anisotropic graphite laminate to cracking, and eventually have completed the present invention.

An aspect of the present invention can provide a graphite composite excellent in thermal diffusion ability with an anisotropic graphite laminate having reduced susceptibility to cracking even in a case where a laminate in which two or more graphite sheets are stacked on top of each other with a resin layer between adjacent graphite sheets is used as the anisotropic graphite laminate. Further, such an effect according to an aspect of the present invention contributes, for example, to achievement of Goal 12 “Ensure sustainable consumption and production patterns” of the Sustainable Development Goals (SDGs) proposed by the United Nations.

### [2. Graphite Composite]

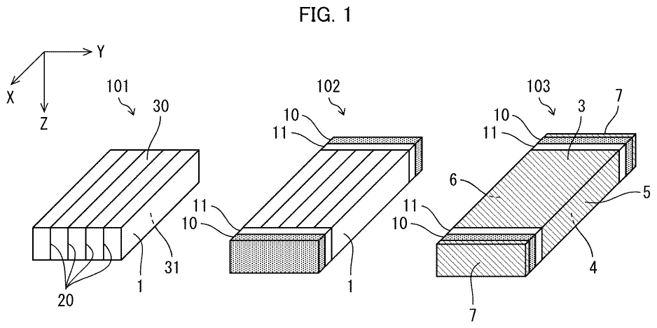

A graphite composite according to an embodiment of the present invention will be described with reference to FIG. 1. FIG. 1 is a diagram illustrating a configuration of the graphite composite according to an embodiment of the present invention.

A graphite composite 103 according to an embodiment of the present invention is a graphite composite including: an anisotropic graphite laminate 1 in which, given an X axis, a Y axis orthogonal to the X axis, and a Z axis perpendicular to the X-Y plane as three spatial axes orthogonal to each other, two or more graphite sheets are stacked on top of each other, in the Y axis direction, with a resin layer between adjacent graphite sheets, and crystal orientation planes 20 of graphite layers are disposed in parallel to the X-Z plane, wherein the anisotropic graphite laminate 1 has a first principal face 30 parallel to the X-Y plane and a second principal face 31 opposite to the first principal face 30; a first metal layer 3 provided on the first principal face 30 of the anisotropic graphite laminate 1; a second metal layer 4 provided on the second principal face 31 of the anisotropic graphite laminate 1; and a reinforcing layer 10 provided on at least one of two surfaces of the anisotropic graphite laminate 1 that are parallel to the Y-Z plane, wherein the first metal layer 3 and the second metal layer 4 each have a thickness of 2 μm to 50 μm.

Herein, “face A is parallel to face B” such as “crystal orientation planes 20 parallel to the X-Z plane” means that face A only needs to be substantially parallel to face B. Here, being substantially parallel means, for example, such a state that the angle between the normal of face A and the normal of face B is −10° to 10°.

As illustrated in 101 in FIG. 1, the graphite composite according to an embodiment of the present invention includes an anisotropic graphite laminate 1 in which crystal orientation planes 20 of graphite layers are disposed in parallel to the X-Z plane, wherein the anisotropic graphite laminate 1 has a first principal face 30 parallel to the X-Y plane and a second principal face 31 opposite to the first principal face 30.

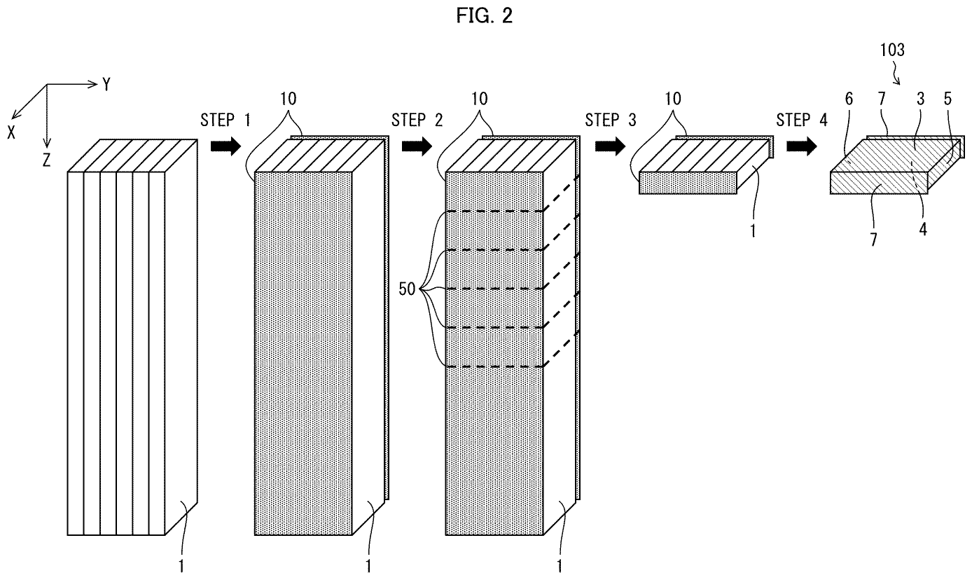

The anisotropic graphite laminate 1 is a laminate in which two or more graphite sheets are stacked on top of each other, in the Y axis direction, with a resin layer between adjacent graphite sheets, and can have a block-like shape (e.g., a cube, a cuboid) (the resin layer is not shown in FIG. 1 and FIG. 2 described later). Here, a graphite sheet has a sheet-like form in which many layers each having a graphite structure in which six-membered rings of carbon atoms are linked together by covalent bonds (in other words, graphite layers) are stacked. Accordingly, in the anisotropic graphite laminate 1, the two or more sheets and the resin layer are disposed in parallel to the X-Z plane in the same manner as the crystal orientation planes 20 of the graphite layers.

For the resin layer, thermosetting resin and/or thermoplastic resin can be used. That is, the resin layer contains at least either one of thermoplastic resin and thermosetting resin. A film-like material or a varnish-like material can be used as the material of the resin layer.

Examples of the thermosetting resin include polyurethane (PU), phenolic resin, vinyl ester resin, unsaturated polyester, epoxy resin, polyimide (PI) resin, polyphenylene ether (PPE), and a combination of two or more of them. Among them, epoxy resin and PU are preferable because of wide material selection and superiority in close adhesion to graphite sheets.

Examples of the thermoplastic resin include acrylic resin, ethylene-vinyl acetate copolymer (EVA) resin, polymethyl methacrylate (PMMA), polyvinyl chloride (PVC), aramid, polyethylene terephthalate (PET), polybutylene terephthalate (PBT), polystyrene (PS), polycarbonate (PC), aromatic polyester, polyethylene naphthalate (PEN), polyester resin, and a combination of two or more of them. Use of a material containing an aromatic substance (such as aromatic polyester and polyethylene terephthalate) as the thermoplastic resin is more preferable. This configuration allows the resin layer to align in substantially parallel to the planes of the graphite sheets when the resin layer is stacked and allows layers of the graphite sheets to be less likely to be disturbed in stacking, thereby successfully giving a graphite laminate having a thermal conductivity close to the theoretical value.

The thermoplastic resin and the thermosetting resin each preferably have a glass transition temperature of 50° C. or more, more preferably has a glass transition temperature of 60° C. or more, even more preferably has a glass transition temperature of 70° C. or more, and particularly preferably has a glass transition temperature of 80° C. or more. With the glass transition temperature of 50° C. or more, intrusion of air into the anisotropic graphite laminate can be prevented in a better manner. The glass transition temperature is preferably 250° C. or less, more preferably 150° C. or less, and even more preferably 100° C. or less. Use of a material having a glass transition temperature of 50° C. or more such as an acrylic pressure-sensitive adhesive and a rubber sheet results in high strength of the resin layer and a tendency of the resin layer to have less variation in properties, thus being preferable. Examples of other materials having such a glass transition temperature include polyethylene terephthalate (PET), polystyrene (PS), and polycarbonate (PC).

The glass transition temperature can be checked by subjecting the resin layer to measurement by differential scanning calorimetry.

The thickness of each of such resin layers is preferably 100 μm or less, more preferably 50 μm or less, most preferably 15 μm or less, and particularly preferably 5 μm or less. The lower limit is preferably 0.1 μm, and more preferably 2 μm. It is preferable that the thickness of the resin layer be 100 μm or less, 50 μm or less, 15 μm or less, or, in particular, 5 μm or less, because reduction in thermal properties by the resin layer is lower. It is preferable in terms of adhesion that the thickness of the resin layer be 0.1 μm or more, or even 2 μm or more.

The thickness of each of the graphite sheets is preferably 2 μm to 50 μm, more preferably 10 μm to 50 μm, and even more preferably 20 μm to 50 μm.

The block-like anisotropic graphite laminate has high thermal conductance in directions (e.g., the X axis direction and the Z axis direction) parallel to the crystal orientation planes 20 of the graphite layers. The word “anisotropic” for the anisotropic graphite laminate 1 means that the graphite layers are oriented and hence there is significant difference between the thermal conductance of the anisotropic graphite laminate 1 in the directions (e.g., the X axis direction and the Z axis direction) parallel to the crystal orientation planes 20 of the graphite layer and that in a direction (e.g., the Y axis direction) perpendicular to the crystal orientation planes 20 of the graphite layers. The anisotropic graphite laminate 1 can be preferably made by using a known technique such as a method described in Patent Literature 1 mentioned above.

Each of the thermal conductivity of the anisotropic graphite laminate 1 in the X axis direction and that in the Z axis direction can be, for example, 1000 W/mK or more. The upper limit of each of the thermal conductivity of the anisotropic graphite laminate 1 in the X axis direction and that in the Z axis direction is not limited to a particular value, and can be 2000 W/mK or less. On the other hand, the thermal conductivity of the anisotropic graphite laminate 1 in the Y axis direction can be, for example, 0.3 W/mK or more and 20 W/mK or less.

The first principal face 30 is a face parallel to the X-Y plane, and the second principal face 31 is a face opposite to the first principal face 30 parallel to the X-Y plane (in other words, a face parallel to the X-Y plane). Accordingly, the anisotropic graphite laminate 1 is capable of efficient heat transport along the Z axis direction (e.g., from the first principal face 30 to the second principal face 31) and/or the X axis direction.

The thickness (the thickness in the Z axis direction) of the anisotropic graphite laminate 1 is not limited, and preferably 0.30 mm to 5.0 mm, more preferably 0.50 mm to 3.0 mm, and most preferably 0.70 mm to 2.0 mm. This configuration enables achievement of a heat-transmitting element that is thin and capable of efficient heat transport.

The thickness of the anisotropic graphite laminate 1 in the X axis direction and that in the Y axis direction are not limited, and can be appropriately set to fit the purpose of use. The thickness of the anisotropic graphite laminate 1 in the X axis direction and that in the Y axis direction can be, for example, 10 mm to 80 mm and 10 mm to 50 mm, respectively.

As illustrated in FIG. 1, the graphite composite 103 according to an embodiment of the present invention includes the first metal layer 3 provided on the first principal face 30 of the anisotropic graphite laminate 1 and the second metal layer 4 provided on the second principal face 31 of the anisotropic graphite laminate 1.

As described above, efficient heat transport occurs along the Z axis direction in the anisotropic graphite laminate 1, and hence heat from the anisotropic graphite laminate 1 can be efficiently transmitted to another structure through the first metal layer 3 and the second metal layer 4.

Since at least part of the surface of the anisotropic graphite laminate 1 is covered by the first metal layer 3 and the second metal layer 4, fall of graphite powder from the anisotropic graphite laminate 1 can be prevented. Achievement of prevention of the fall of the graphite powder from the anisotropic graphite laminate 1 can lead to successful prevention of a short circuit caused by graphite powder in an electronic circuit when the graphite composite according to an embodiment of the present invention is disposed in electronic equipment.

In addition, the susceptibility of the anisotropic graphite laminate 1 to cracking can be further reduced with the first metal layer 3 and the second metal layer 4.

Although the first metal layer 3 and the second metal layer 4 may be provided to be in direct contact with the anisotropic graphite laminate 1 or provided not to be in direct contact with the anisotropic graphite laminate 1, it is more preferable that the first metal layer 3 and the second metal layer 4 be provided to be in direct contact with the anisotropic graphite laminate 1. This configuration allows direct transfer of heat between the anisotropic graphite laminate 1 and each of the first metal layer 3 and second metal layer 4, and hence a heat-transmitting element that is thin and capable of efficient heat transport can be achieved. In addition, with the configuration, at least part of the surface of the anisotropic graphite laminate 1 can be more reliably covered by the first metal layer 3 and the second metal layer 4, and the susceptibility of the anisotropic graphite laminate 1 to cracking can be more reliably reduced.

The first metal layer 3 and the second metal layer 4 are not limited to a particular configuration, and each can be a metal vapor deposition layer, a metal layer formed by sputtering treatment, a metal layer formed by thermal spraying, a plating layer, or a metal layer containing a metal brazing material. This configuration allows the first metal layer 3 and the second metal layer 4 to be thin, and hence a heat-transmitting element that is thin and capable of efficient heat transport can be achieved. In addition, the configuration allows the first metal layer 3 and the second metal layer 4 to be formed on the anisotropic graphite laminate 1 without interposition of any other structure. Because the anisotropic graphite laminate has lower thermal resistance due to the presence of the resin layer than that in the absence of the resin layer, the first metal layer 3 and the second metal layer 4 are each preferably configured to be a plating layer, for formation of which high-temperature conditions are not needed. Although it is desirable in terms of thermal diffusion ability that the structure to be provided on each principal face of the anisotropic graphite laminate include only a metal layer, the plating layer may be an integrated product of a metal layer and an inorganic material layer.

The materials of the first metal layer 3 and the second metal layer 4 are not limited to particular materials, and each preferably contain at least one selected from the group consisting of copper, nickel, and gold. Accordingly, each of the materials of the first metal layer 3 and the second metal layer 4 may contain all of copper, nickel, and gold, or contain copper and nickel, or contain copper and gold, or contain nickel and gold, or contain any one of copper, nickel, and gold. Each of the materials of the first metal layer 3 and the second metal layer 4 preferably contains copper among those materials, more preferably being copper. The configuration enables achievement of a heat-transmitting element with cost advantage and efficient heat transport in combination.

The thicknesses (the thicknesses in the Z axis direction) of the first metal layer 3 and the second metal layer 4 are each independently 2 μm to 50 μm, preferably 3 μm to 30 μm, and more preferably 5 μm to 10 μm. This configuration enables achievement of a heat-transmitting element capable of more efficient heat transport.

As illustrated in FIG. 1, in the graphite composite 103 according to an embodiment of the present invention, a third metal layer 5 and a fourth metal layer 6 are preferably respectively provided on one and the other of two surfaces of the anisotropic graphite laminate 1 that are parallel to the X-Z plane.

Since at least part of the surface of the anisotropic graphite laminate 1 is covered by the third metal layer 5 and the fourth metal layer 6, fall of the graphite powder from the anisotropic graphite laminate 1 can be prevented.

In addition, the susceptibility of the anisotropic graphite laminate 1 to cracking can be further reduced with the third metal layer 5 and the fourth metal layer 6.

Although the third metal layer 5 and the fourth metal layer 6 may be provided to be in direct contact with the anisotropic graphite laminate 1 or provided not to be in direct contact with the anisotropic graphite laminate 1, it is more preferable that the third metal layer 5 and the fourth metal layer 6 be provided to be in direct contact with the anisotropic graphite laminate 1. With this configuration, at least part of the surface of the anisotropic graphite laminate 1 can be more reliably covered by the third metal layer 5 and the fourth metal layer 6, and the susceptibility of the anisotropic graphite laminate 1 to cracking can be more reliably reduced.

The configuration of the third metal layer 5 and the fourth metal layer 6 can be the same as that of the first metal layer 3 and the second metal layer 4. Heat transport efficiently occurs primarily along the X axis and the Z axis and heat transport occurs marginally along the Y axis, and hence the third metal layer 5 and the fourth metal layer 6 may be each a metal layer formed with interposition of an organic adhesive.

The thicknesses (the thicknesses in the Y axis direction) of the third metal layer 5 and the fourth metal layer 6 are not limited to particular values, and preferably each independently 2 μm to 50 μm, more preferably 3 μm to 30 μm, and most preferably 5 μm to 10 μm. With this configuration, not only fall of graphite powder from the anisotropic graphite laminate 1 can be prevented, but also a thin heat-transmitting element can be achieved.

As illustrated in FIG. 1, the graphite composite 103 according to an embodiment of the present invention includes a reinforcing layer 10 provided on at least one of the two surfaces of the anisotropic graphite laminate 1 that are parallel to the Y-Z plane. In the graphite composite 103 according to an embodiment of the present invention, the reinforcing layer 10 is more preferably provided on each of the two surfaces of the anisotropic graphite laminate 1 that are parallel to the Y-Z plane. Schematically illustrated in 102 in FIG. 1 is a configuration in which the first metal layer 3, the second metal layer 4, the third metal layer 5, and the fourth metal layer 6 are not provided.

The anisotropic graphite laminate has a character of susceptibility to cracking along the X-Z plane (crystal orientation planes 20). Accordingly, the susceptibility of the anisotropic graphite laminate 1 to cracking can be reduced by providing the reinforcing layer 10 on at least one of the two surfaces parallel to the Y-Z plane.

The thicknesses (the thicknesses in the X axis direction) of such reinforcing layers 10 are not limited, and preferably each independently 50 μm to 500 μm, more preferably 100 μm to 400 μm, and most preferably 150 μm to 300 μm. With this configuration, not only can the susceptibility of the anisotropic graphite laminate 1 to cracking be reduced, but also a thin heat-transmitting element can be achieved.

The thickness of the reinforcing layer 10 in the Y axis direction and that in the Z axis direction are not limited, and can be appropriately set to fit the size of the anisotropic graphite laminate 1.

The material of the reinforcing layer 10 is not limited to a particular material, and preferably contains at least one selected from the group consisting of resins (e.g., polypropylene, polyethylene, polyethylene terephthalate, polycarbonate, modified resins with addition of various additives, elastomer), metals (e.g., gold, silver, copper, nickel, aluminum, molybdenum, tungsten, alloy containing any of them, and metal brazing material), and ceramics (e.g., alumina, zirconia, silicon carbide, silicon nitride, boron nitride, and aluminum nitride). With this configuration, the susceptibility of the anisotropic graphite laminate 1 to cracking can be suppressed. For obtaining the advantage in a better manner, polycarbonate and polyethylene terephthalate are even more preferable among the resins, copper and aluminum are even more preferable among the metals, and alumina and silicon carbide are even more preferable among the ceramics.

As illustrated in FIG. 1, the graphite composite according to an embodiment of the present invention may include an adhesive layer 11 between the anisotropic graphite laminate 1 and the reinforcing layer 10. This configuration can make the anisotropic graphite laminate 1 and the reinforcing layer 10 adhere to each other with the adhesive layer 11 therebetween.

The adhesive layer 11 only needs to be able to make the anisotropic graphite laminate 1 and the reinforcing layer 10 adhere to each other, and the configuration of the adhesive layer 11 is not limited. Examples of a material of the adhesive layer 11 can include metal brazing materials, acrylic adhesives, epoxy adhesives, solder, pressure-sensitive adhesives, and various pressure-sensitive adhesive tapes. Among them, acrylic adhesives, epoxy adhesives, pressure-sensitive adhesives, and various pressure-sensitive adhesive tapes, for which high-temperature conditions are not needed, are more preferable as the material of the adhesive layer 11 because the anisotropic graphite laminate has lower thermal resistance due to the presence of the resin layer than that in the absence of the resin layer.

Examples of the pressure-sensitive adhesive tapes include acrylic resin pressure-sensitive adhesive tape, epoxy resin pressure-sensitive adhesive tape, fluororesin pressure-sensitive adhesive tape, silicone pressure-sensitive adhesive tape, and polyimide pressure-sensitive adhesive tape, and silicone pressure-sensitive adhesive tape and polyimide pressure-sensitive adhesive tape are more preferable in terms of thermal resistance.

In the case that pressure-sensitive adhesive tape is used for the adhesive layer 11, the pressure-sensitive adhesive tape is cut to give a piece of arbitrary size according to a known method, and the reinforcing layer 10 can be made to adhere to the anisotropic graphite laminate 1 with the piece. To obtain a good joint state of the reinforcing layer 10 and the anisotropic graphite laminate 1, a load may be applied from the reinforcing layer 10 to the anisotropic graphite laminate 1 in affixing.

The thicknesses (the thicknesses in the X axis direction) of such adhesive layers 11 are not limited, and preferably each independently 5 μm to 500 μm, more preferably 8 μm to 100 μm, and most preferably 8 μm to 50 μm. With this configuration, not only can the anisotropic graphite laminate 1 and the reinforcing layers 10 be made to firmly adhere to each other, but also a thin heat-transmitting element can be achieved.

The thickness of the adhesive layer 11 in the Y axis direction and that in the Z axis direction are not limited, and can be appropriately set to fit the size of the anisotropic graphite laminate 1.

The graphite composite 103 according to an embodiment of the present invention may include a fifth metal layer 7 on the outer side of the reinforcing layer 10 (in other words, on the opposite side of the reinforcing layer 10 to the adhesive layer 11).

Since at least part of a surface of the reinforcing layer 10 (in other words, at least part of the surface of the anisotropic graphite laminate 1) is covered by the fifth metal layer 7, fall of graphite powder from the anisotropic graphite laminate 1 can be prevented in a better manner.

In addition, the susceptibility of the anisotropic graphite laminate 1 to cracking can be further reduced with the fifth metal layer 7.

The configuration of the fifth metal layer 7 is not limited to a particular configuration, and can be the same as that of the first metal layer 3 and the second metal layer 4.

The thicknesses (the thicknesses in the X axis direction) of such fifth metal layers 7 are not limited to particular values, and preferably each independently 2 μm to 50 μm, more preferably 3 μm to 30 μm, and most preferably 5 μm to 10 μm. With this configuration, not only can fall of graphite powder from the anisotropic graphite laminate 1 be prevented, but also a thin heat-transmitting element can be achieved.

The thickness of the fifth metal layer 7 in the Y axis direction and that in the Z axis direction are not limited, and can be appropriately set to fit the size of the anisotropic graphite laminate 1.

A reinforcing layer may be formed also on a face parallel to the X-Z plane. That is, the graphite composite according to an embodiment of the present invention may include a reinforcing layer provided on at least one of the two surfaces of the anisotropic graphite laminate that are parallel to the X-Z plane (or on each of the two surfaces parallel to the X-Z plane).

A configuration on the outer side of the two surfaces of the anisotropic graphite laminate that are parallel to the X-Z plane can be the same as a configuration on the outer side of the two surfaces of the anisotropic graphite laminate that are parallel to the Y-Z plane (e.g., a configuration including the reinforcing layer 10, a configuration including the reinforcing layer 10 and the adhesive layer 11, or a configuration including the reinforcing layer 10, the adhesive layer 11, and the seventh metal layer).

### [2. Method for Producing Graphite Composite]

A method for producing a graphite composite 103 according to an embodiment of the present invention will be described with reference to FIG. 1 and

FIG. 2. In the following, description is omitted for content that has been described in the section [1. Graphite Composite].

The method for producing a graphite composite 103 according to an embodiment of the present invention is a method for producing a graphite composite 103 including an anisotropic graphite laminate 1 in which, given an X axis, a Y axis orthogonal to the X axis, and a Z axis perpendicular to the X-Y plane as three spatial axes orthogonal to each other, two or more graphite sheets are stacked on top of each other, in the Y axis direction, with a resin layer between adjacent graphite sheets, and crystal orientation planes 20 of graphite layers are disposed in parallel to the X-Z plane, wherein the anisotropic graphite laminate 1 has a first principal face 30 parallel to the X-Y plane and a second principal face 31 opposite to the first principal face 30, the method including: a reinforcing step of forming a reinforcing layer 10 on at least one of two surfaces of the anisotropic graphite laminate 1 that are parallel to the Y-Z plane; and a metal layer formation step of forming a first metal layer 3 and a second metal layer 4 respectively on the first principal face 30 and second principal face 31 of the anisotropic graphite laminate 1 with the reinforcing layer 10 formed thereon, wherein the first metal layer 3 and the second metal layer 4 each have a thickness of 2 μm to 50 μm.

The reinforcing step is a step of forming a reinforcing layer 10 on at least one of the two surfaces of the anisotropic graphite laminate 1 that are parallel to the Y-Z plane (or on each of the two surfaces of the anisotropic graphite laminate 1 that are parallel to the Y-Z plane) (see STEP 1 in FIG. 2).

The specific configuration of the reinforcing step is not limited to a particular configuration; for example, (i) the reinforcing layer 10 may be made to directly adhere to the anisotropic graphite laminate 1, or (ii) the reinforcing layer 10 may be made to adhere to the anisotropic graphite laminate 1 with an adhesive layer 11 therebetween. In making the anisotropic graphite laminate 1 and the reinforcing layer 10 adhere to each other with the adhesive layer 11 therebetween, a known method that fits the raw material of the adhesive layer 11 can be appropriately used.

In the case that pressure-sensitive adhesive tape is used as the adhesive layer 11, the pressure-sensitive adhesive tape is cut to give a piece of arbitrary size according to a known method, and the reinforcing layer 10 can be made to adhere to the anisotropic graphite laminate 1 with the piece of the pressure-sensitive adhesive tape. To obtain a good joint state of the reinforcing layer 10 and the anisotropic graphite laminate 1, a load may be applied from the reinforcing layer 10 to the anisotropic graphite laminate 1 in affixing.

The method for producing the graphite composite 103 according to an embodiment of the present invention preferably includes a cutting step of cutting the reinforcing layer 10 and the anisotropic graphite laminate 1 (in other words, the composite of the reinforcing layer 10 and the anisotropic graphite laminate 1) after the reinforcing step.

In the cutting step, for example, the composite of the reinforcing layer 10 and the anisotropic graphite laminate 1 can be cut along cutting planes 50 parallel to the X-Y plane (see STEP 2 to STEP 3 in FIG. 2). With this configuration, a plurality of precursors of the graphite composite 103 can be obtained from one large block. Furthermore, a plurality of graphite composites, each being the graphite composite 103, can be efficiently produced from the precursors.

The specific process in the cutting step is not limited to a particular process, and examples of the specific process include cutting with a wire saw, cutting with a mold, and cutting with a laser. Among them, cutting with a wire saw is more preferable because the advantage of productivity is obtained.

The metal layer formation step is a step of forming a first metal layer 3 and a second metal layer 4 respectively on the first principal face 30 and second principal face 31 of the anisotropic graphite laminate 1 with the reinforcing layer 10 formed thereon (see STEP 4 in FIG. 2).

It is preferable to form the first metal layer 3 and the second metal layer 4 simultaneously in the metal layer formation step. With this configuration, the graphite composites can be efficiently produced.

In the metal layer formation step, the first metal layer 3, the second metal layer 4, a third metal layer 5, and a fourth metal layer 6 may be simultaneously formed. In the metal layer formation step, a fifth metal layer 7 may be formed in addition to and simultaneously with the first metal layer 3 to the fourth metal layer 6. With this configuration, the graphite composites with fall of graphite powder from the anisotropic graphite laminate 1 prevented in a better manner can be efficiently produced.

The method of forming the first metal layer 3, the second metal layer 4, the third metal layer 5, the fourth metal layer 6, and the fifth metal layer 7 is not limited to a particular method, and a known method that fits raw materials of these metal layers can be appropriately used. Examples of the method can include plating treatment, affixing of a metal film to which an adhesive has been attached, metal vapor deposition, and sputtering treatment. With that configuration, metal layers including the first metal layer 3 and the second metal layer 4 can be directly formed on a structure including the anisotropic graphite laminate 1.

In the case that metal layers (e.g., the first metal layer 3, the second metal layer 4, the third metal layer 5, the fourth metal layer 6, and the fifth metal layer 7) are formed by plating treatment or the like and thereafter the reinforcing layer 10 is provided to the anisotropic graphite laminate 1, the anisotropic graphite laminate 1 needs to be put in a plating bath while being gripped with a gripping tool in plating treatment of the anisotropic graphite laminate 1. At the time of the plating treatment, a part where a metal layer is not formed is likely to be generated at a contact point with the gripping tool on the surface of the anisotropic graphite laminate 1. This is likely to lead to fall of graphite powder from the anisotropic graphite laminate 1. In addition, the anisotropic graphite laminate 1 is likely to crack because of vibration generated in forming a metal layer.

The mentioned problems can be solved by performing the metal layer formation step after the reinforcing step.

The method for producing the graphite composite 103 according to an embodiment of the present invention can further include an anisotropic graphite laminate production step of producing the anisotropic graphite laminate 1.

The anisotropic graphite laminate production step can include a stacking step of alternately stacking a graphite sheet and a resin layer to form a stacked product. Suppose that crystal orientation planes of graphite layers in graphite sheets are disposed in parallel to the X-Z plane, the stacking step is a step of alternately stacking, in the Y axis direction perpendicularly intersecting with the surfaces, a graphite sheet and a resin layer with their surfaces overlapped, to form a stacked product.

Examples of specific methods for the stacking step can include (i) a method of alternately stacking a graphite sheet and a resin layer, and (ii) a method of disposing a resin layer on at least one face of a graphite sheet to make a graphite-attached sheet and then stacking such graphite-attached sheets to form a multilayer.

Preferably, the anisotropic graphite laminate production step further includes an adhesion step of heat-fusing the graphite sheets and resin layers by heating the stacked product to form the anisotropic graphite laminate 1.

### <Summary>

An embodiment of the present invention includes the following configurations.

[1] A graphite composite including:
an anisotropic graphite laminate in which, given an X axis, a Y axis orthogonal to the X axis, and a Z axis perpendicular to the X-Y plane as three spatial axes orthogonal to each other, two or more graphite sheets are stacked on top of each other, in the Y axis direction, with a resin layer between adjacent graphite sheets, and crystal orientation planes of graphite layers are disposed in parallel to the X-Z plane, wherein the anisotropic graphite laminate has a first principal face parallel to the X-Y plane and a second principal face opposite to the first principal face;
a first metal layer provided on the first principal face of the anisotropic graphite laminate;
a second metal layer provided on the second principal face of the anisotropic graphite laminate; and
a reinforcing layer provided on at least one of two surfaces of the anisotropic graphite laminate that are parallel to the Y-Z plane, wherein
the first metal layer and the second metal layer each have a thickness of 2 μm to 50 μm.

[2] The graphite composite according to [1], wherein the reinforcing layer has a thickness of 50 μm to 500 μm.

[3] The graphite composite according to [1] or [2], wherein the first metal layer and the second metal layer are in direct contact with the anisotropic graphite laminate.

[4] The graphite composite according to claim 3, wherein the first metal layer and the second metal layer each contain at least one selected from the group consisting of copper, nickel, and gold.

[5] The graphite composite according to any one of [1] to [4], wherein the anisotropic graphite laminate has a thickness of 0.30 mm to 5.0 mm in the Z axis direction.

[6] The graphite composite according to any one of [1] to [5], wherein the reinforcing layer contains at least one selected from the group consisting of resin, metal, and ceramic.

[7] The graphite composite according to any one of [1] to [6], wherein the reinforcing layer is provided on each of the two surfaces of the anisotropic graphite laminate that are parallel to the Y-Z plane.

[8] The graphite composite according to [7], wherein a fifth metal layer is provided on the reinforcing layer provided on each of the two surfaces of the anisotropic graphite laminate that are parallel to the Y-Z plane.

[9] The graphite composite according to any one of [1] to [8], wherein a third metal layer and a fourth metal layer are respectively provided on one and the other of the two surfaces of the anisotropic graphite laminate that are parallel to the X-Z plane.

[10] The graphite composite according to claim 9, wherein the third metal layer and the fourth metal layer are in direct contact with the anisotropic graphite laminate.

[11] The graphite composite according to any one of [1] to [10], wherein
the resin layer contains at least either one of thermoplastic resin and thermosetting resin, and
the resin layer has a glass transition temperature of 50° C. or more.

[12] A method for producing a graphite composite including an anisotropic graphite laminate in which, given an X axis, a Y axis orthogonal to the X axis, and a Z axis perpendicular to the X-Y plane as three spatial axes orthogonal to each other, two or more graphite sheets are stacked on top of each other, in the Y axis direction, with a resin layer between adjacent graphite sheets, and crystal orientation planes of graphite layers are disposed in parallel to the X-Z plane, wherein the anisotropic graphite laminate has a first principal face parallel to the X-Y plane and a second principal face opposite to the first principal face, the method including:
a reinforcing step of forming a reinforcing layer on at least one of two surfaces of the anisotropic graphite laminate that are parallel to the Y-Z plane; and
a metal layer formation step of forming a first metal layer and a second metal layer respectively on the first principal face and second principal face of the anisotropic graphite laminate with the reinforcing layer formed thereon, wherein
the first metal layer and the second metal layer each have a thickness of 2 μm to 50 μm.

[13] The method for producing a graphite composite according to [12], including a cutting step of cutting the reinforcing layer and the anisotropic graphite laminate after the reinforcing step and before the metal layer formation step.

[14] The method for producing a graphite composite according to [12] or [13], wherein the first metal layer and the second metal layer are simultaneously formed in the metal layer formation step.

[15] The method for producing a graphite composite according to any one of [12] to [14], wherein
the resin layer contains at least either one of thermoplastic resin and thermosetting resin, and
the resin layer has a glass transition temperature of 50° C. or more.

[16] The graphite composite according to any one of [1] to [11], wherein the resin layer has a thickness of 100 μm or less.

[17] The graphite composite according to any one of [1] to [11], wherein the graphite sheets each have a thickness of 2 μm to 50 μm.

[18] The graphite composite according to any one of [1] to [11], wherein the anisotropic graphite laminate has a thermal conductivity of 1000 W/mK or more in the X axis direction and the Z axis direction.

[19] The graphite composite according to [9] or [10], wherein the third metal layer and the fourth metal layer each have a thickness of 2 μm to 50 μm.

[20] The graphite composite according to any one of [1] to [11], including an adhesive layer between the anisotropic graphite laminate and the reinforcing layer.

[21] The graphite composite according to [20], wherein the adhesive layer has a thickness of 5 μm to 500 μm.

[22] The graphite composite according to any one of [1] to [11], including a reinforcing layer provided on at least one of two surfaces of the anisotropic graphite laminate that are parallel to the X-Z plane.

[23] The graphite composite according to [8], wherein the fifth metal layer have a thickness of 2 μm to 50 μm.

### EXAMPLES

The following describes an embodiment of the present invention in more detail with Examples and Comparative Examples, but the present invention is not limited by them.

### <Production of Anisotropic Graphite Laminate and Graphite Composite>

### (Graphite Composite (A-1): Example 1)

Used was a graphite sheet (referred to as GS1) having a thickness of 36 μm, an in-plane thermal conductivity of 1650 W/mK, and a density of 2.0 g/cm², which had been obtained by heat-treating a polyimide film.

GS1 of 100 mm×100 mm in size and a polyester film (thickness: 5 μm, dielectric constant: 3.2, melting point: 260° C.) were alternately stacked until the number of sheets of GS1 reached 1097. To a resulting stack, a pressure of 0.5 MPa was applied for 1 minute with a pressing machine heated to 250° C. to make a graphite lamination block (100 mm×100 mm, thickness: 45 mm). The stacking was performed in such a manner that an uppermost layer and a lowermost layer of the graphite lamination block each consisted of a graphite sheet.

The resulting graphite lamination block (100 mm×100 mm, thickness: 45 mm) was cut with a wire saw to give an anisotropic graphite laminate 1. The dimensions of the anisotropic graphite laminate 1 were such that, in a case where crystal orientation planes of the anisotropic graphite laminate 1 were disposed in parallel to the X-Z plane, the length of each side parallel to the X axis was 39.53 mm, the length of each side parallel to the Y axis was 29.99 mm, and the length of each side parallel to the Z axis was 80 mm.

Next, a layer of oxygen-free copper of 29.99 mm×80 mm×thickness 150 μm as a reinforcing layer 10 was made to adhere on each of two surfaces of the anisotropic graphite laminate 1 that were parallel to the Y-Z plane with a piece of adhesive tape of 29.99 mm×80 mm×85 μm (the heat-resistant double-sided tape API214A-50X10 manufactured by Chukoh Chemical Industries, Ltd. was cut into a piece of proper size and used) as an adhesive layer 11 between the reinforcing layer 10 and each of the two surfaces.

Thereafter, a composite was cut in parallel to the X-Y plane with a wire saw to give a resulting composite of arbitrary thickness. The resulting composite was subjected to plating treatment to precipitate a layer of nickel having a thickness of 5 μm on the surface, giving a graphite composite (A-1) coated by metal (corresponding to the first metal layer 3 and the second metal layer 4).

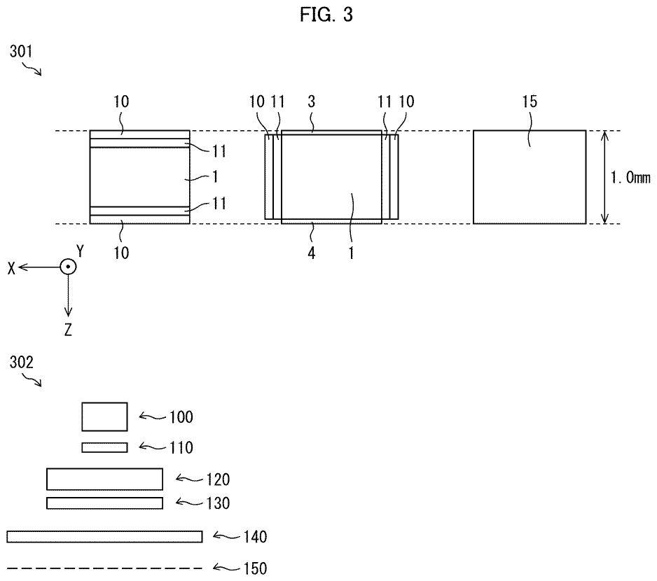

A schematic of a configuration of the graphite composite (A-1) is shown in the center diagram of three diagrams indicated by the reference numeral 301 in FIG. 3, and the dimensions of the graphite composite (A-1) are shown in the following:
size of anisotropic graphite laminate 1 in X-Y plane: 39.53 mm×29.99 mm,
thickness of anisotropic graphite laminate 1 in Z axis direction: 0.99 mm,
thickness of each of first metal layer 3 and second metal layer 4 in Z axis direction: 5 μm,
thickness of adhesive layer 11 in X axis direction: 85 μm,
thickness of adhesive layer 11 in Z axis direction: 0.99 mm,
thermal conductivity of adhesive layer 11: 0.2 W/mK,
thickness of reinforcing layer 10 in X axis direction: 150 μm, and
thickness of reinforcing layer 10 in Z axis direction: 0.99 mm.

### (Graphite Composite (A-2): Example 2)

Used as with the case of the graphite composite (A-1) was a graphite sheet (GS1) having a thickness of 36 μm, an in-plane thermal conductivity of 1650 W/mK, and a density of 2.0 g/cm², which had been obtained by heat-treating a polyimide film. A pressure-sensitive adhesive sheet (manufactured by DIC Corporation, #8602TNW-05, thickness: 5 μm) was laminated on one face of GS1 of 100 mm×100 mm in size, and 1097 sheets of GS1 having been subjected to lamination were stacked in such a manner that each GS1 face was in contact with a pressure-sensitive adhesive face of a pressure-sensitive adhesive sheet to be attached to the GS1 face. To a resulting stack, a pressure of 0.5 MPa was applied for 1 minute to make a graphite lamination block (100 mm×100 mm, thickness: 45 mm). Only for an uppermost sheet, GS1 with no pressure-sensitive adhesive sheet laminated thereon was used. Thereafter, a resulting graphite lamination block was cut with a wire saw to give a graphite laminate 2. The dimensions of the anisotropic graphite laminate 2 were such that, in a case where crystal orientation planes of the anisotropic graphite laminate 2 were disposed in parallel to the X-Z plane, the length of each side parallel to the X axis was 39.53 mm, the length of each side parallel to the Y axis was 29.99 mm, and the length of each side parallel to the Z axis was 80 mm.

Next, a layer of oxygen-free copper of 29.99 mm×80 mm×thickness 150 μm as a reinforcing layer 10 was made to adhere on each of two surfaces of the anisotropic graphite laminate 2 that were parallel to the Y-Z plane with a piece of adhesive tape of 29.99 mm×80 mm×85 μm (the heat-resistant double-sided tape API214A-50X10 manufactured by Chukoh Chemical Industries, Ltd. was cut into a piece of proper size and used) as an adhesive layer 11 between the reinforcing layer 10 and each of the two surfaces.

A resulting composite was subjected to plating treatment to precipitate a layer of nickel having a thickness of 5 μm on the surface, giving a graphite composite (A-2) coated by metal (corresponding to the first metal layer 3 and the second metal layer 4).

The configuration and dimensions of the graphite composite (A-2) are the same as those of the graphite composite (A-1).

### (Graphite Composite (B): Comparative Example 1)

The graphite lamination block (90 mm×90 mm, thickness: 45 mm) made in the above section “Graphite composite (A-1)” was cut with a wire saw to give an anisotropic graphite laminate 3. The dimensions of the anisotropic graphite laminate 3 were such that, in a case where crystal orientation planes of the anisotropic graphite laminate 3 were disposed in parallel to the X-Z plane, the length of each side parallel to the X axis was 40 mm, the length of each side parallel to the Y axis was 30 mm, and the length of each side parallel to the Z axis was 0.68 mm. It should be noted that although the length of each side parallel to the Y axis can be arbitrarily adjusted in cutting, the length is preferably 0.5 mm or more in view of susceptibility to cracking.

Next, an acrylic adhesive of 40 mm×30 mm×10 μm as an adhesive layer 11 was superposed on each of the top face and bottom face (each of two surfaces parallel to the X-Y plane) of the anisotropic graphite laminate 1 in which crystal orientation planes of the anisotropic graphite laminate 1 were disposed in parallel to the X-Z plane as described above, and a layer of oxygen-free copper of 40 mm×30 mm×thickness 150 μm as a reinforcing layer 10 was then superposed on the outer side of each adhesive layer 11; this method gave a composite (B) in which the length of each side parallel to the X axis was 40 mm, the length of each side parallel to the Y axis was 30 mm, and the length of each side parallel to the Z axis was 1 mm.

A schematic of a configuration of the graphite composite (B) is shown in the left diagram of the three diagrams indicated by the reference numeral 301 in FIG. 3, and the dimensions of the graphite composite (B) are shown in the following:
size of anisotropic graphite laminate 1 in X-Y plane: 40 mm×30 mm,
thickness of anisotropic graphite laminate 1 in Z axis direction: 0.68 mm,
thickness of adhesive layer 11 in Z axis direction: 10 μm,
thermal conductivity of adhesive layer 11: 0.2 W/mK, and
thickness of reinforcing layer 10 in Z axis direction: 150 μm.

### (Copper Plate (C): Comparative Example 2)

A schematic of a configuration of a copper plate (C) (copper plate 15) is shown in the right diagram of the three diagrams indicated by the reference numeral 301 in FIG. 3, and the dimensions of the copper plate (C) are shown in the following:
thickness of copper plate (C) in X axis direction: 40 mm,
thickness of copper plate (C) in Z axis direction: 1.0 mm, and
thickness of copper plate (C) in Y axis direction: 30 mm.

### <Evaluation of Heat Transmission Performance>

Respective heat transmission performances of the graphite composite (A-1), the graphite composite (A-2), the graphite composite (B), and the copper plate (C) described above were evaluated.

The anisotropic graphite laminate had a thermal conductivity of 1450 W/mK in the direction parallel to the crystal orientation planes and a thermal conductivity of 1 W/mK in the direction perpendicular to the crystal orientation planes.

It was confirmed that the glass transition temperature of resin layers in the anisotropic graphite laminate made with the method described in the section “Graphite composite (A-1)” was 50° C. or more, and the glass transition temperature of resin layers in the anisotropic graphite laminate made with the method described in the section “Graphite composite (A-2)” was 50° C. or more. The glass transition temperatures were measured, at a temperature increase rate of 1° C./min), with a DSC-50 manufactured by Shimadzu Corporation.

Illustrated in 302 in FIG. 3 is a schematic of an evaluation method for thermal conduction performance. As illustrated in 302 in FIG. 3, in order from the top, a heat source 100 (150 W, 10 mm×20 mm), an adhesive 110 (TIM1 (t=0.2 mm), 5 W/mK), a test sample 120 (graphite composite (A-1), (A-2), graphite composite (B), or copper plate (C)), a solder layer 130 (t=0.05 mm, 40 W/mK), and a copper plate 140 (100 mm×100 mm, t=0.5 mm) were disposed, and a heat transfer coefficient 150 (heat transfer coefficient: 10 KW/m²K, ambient temperature: 50° C.) was set for the lower side of the copper plate 140. Here, t denotes thickness.

The test sample 120 was disposed in each case in such a manner that each of two faces parallel to the X-Y plane shown in 301 in FIG. 3 was in contact with the adhesive 110 or the solder layer 130.

In simple terms, a thermal simulation system in which the test sample 120 was inserted between the heat source 100 and the copper plate 140 with the adhesive 110 between the test sample 120 and the heat source 100 and with the solder layer 130 between the test sample 120 and the copper plate 140 was prepared (using Solidworks). The heat transfer coefficient 150 was set for the lower side of the copper plate 140 which is a side opposite to the solder layer 130, and a space other than the lower side of the copper plate 140 was set to be thermally insulated. With the heat generation rate of the heat source 100 set to 150 W, the external temperature set to 50° C., and the heat transfer coefficient set to 10000 W/m²K, the maximum temperature of the heat source 100 was measured.

In this test, heat from the heat source 100 is to be dissipated through the test sample 120 to an environment with the heat transfer coefficient 150. Therefore, the higher the thermal diffusion ability of the test sample 120, the lower the maximum temperature of the heat source 100.

Measurement results showed that the maximum temperature of the heat source 100 was 106° C. in the test with the graphite composite (A-1) (Example 1) and the test with the graphite composite (A-2) (Example 2), 145° C. in the test with the graphite composite (B) (Comparative Example 1), and 112° C. in the test with the copper plate (C) (Comparative Example 2).

That is, the graphite composites (A-1) and (A-2) according to the examples of the present invention were revealed to efficiently dissipate heat from the heat source 100 to efficiently lower the temperature of the heat source 100, thus having excellent thermal diffusion ability.

### <Evaluation of Strength>

Used were (a) a structure consisting only of the anisotropic graphite laminate 1 included in the graphite composite (A-1), which had been produced in Example 1, (b) a structure consisting only of the anisotropic graphite laminate 1, the adhesive layer 11, and the reinforcing layer 10 included in the graphite composite (A-1), and (c) the graphite composite (A-1). A structure (c) included metal coating films (the first metal layer 3, the second metal layer 4, the third metal layer 5, the fourth metal layer 6, and the fifth metal layers 7) in addition to the structure (b).

For each of the above-described structures (a) to (c), a three-point bending test was carried out at 50 mm/min with a three-point bending apparatus (manufactured by IMADA CO., LTD.) to measure stress at rupture for each of the structures (a) to (c).

Results of the test showed that the structure (a) ruptured at a stress of approximately 3 N, the structure (b) ruptured at a stress of approximately 13 N, and the structure (c) ruptured at a stress of approximately 15 N to 16 N.

Used were (a) a structure consisting only of the anisotropic graphite laminate 2 included in the graphite composite (A-2), which had been produced in Example 2, (b) a structure consisting only of the anisotropic graphite laminate 2, the adhesive layer 11, and the reinforcing layer 10 included in the graphite composite (A-2), and (c) the graphite composite (A-2). Except for this, the same metal layers as those in the above-described evaluation method were formed and the same test method as the above-described test method was used to carry out a three-point bending test, so that stress at rupture for each of the structures (a) to (c) was measured.

Results of the test showed that the structure (a) ruptured at a stress of approximately 4 N, the structure (b) ruptured at a stress of approximately 13 N, and the structure (c) ruptured at a stress of approximately 16 N to 17 N.

That is, it was revealed that in each of the graphite composites according to the examples of the present invention, the susceptibility of the anisotropic graphite laminate to cracking was reduced.

### INDUSTRIAL APPLICABILITY

The present invention is applicable to heat-transmitting elements, more specifically, heat-transmitting elements for electronic equipment and devices.

### REFERENCE SIGNS LIST

1 anisotropic graphite laminate
3 first metal layer
4 second metal layer
5 third metal layer
6 fourth metal layer
7 fifth metal layer
10 reinforcing layer
11 adhesive layer
15 copper plate
20 crystal orientation plane
30 first principal face
31 second principal face
50 cutting plane
100 heat source
103 graphite composite
110 adhesive
120 test sample
130 solder layer
140 copper plate
150 heat transfer coefficient

1. A graphite composite comprising:
an anisotropic graphite laminate in which, given an X axis, a Y axis orthogonal to the X axis, and a Z axis perpendicular to an X-Y plane as three spatial axes orthogonal to each other, two or more graphite sheets are stacked on top of each other, in the Y axis direction, and a resin layer between adjacent graphite sheets, and crystal orientation planes of graphite layers are disposed in parallel to an X-Z plane, wherein the anisotropic graphite laminate has a first principal face parallel to the X-Y plane and a second principal face opposite to the first principal face;
a first metal layer provided on the first principal face of the anisotropic graphite laminate;
a second metal layer provided on the second principal face of the anisotropic graphite laminate; and
a first reinforcing layer provided on a first of two surfaces of the anisotropic graphite laminate that is parallel to the Y-Z plane, wherein
the first metal layer and the second metal layer each have a thickness of 2 μm to 50 μm, and
the first reinforcing layer has a thickness of 50 μm to 500 μm.

2. (canceled)

3. The graphite composite according to claim 1, wherein the first metal layer and the second metal layer are in direct contact with the anisotropic graphite laminate.

4. The graphite composite according to claim 3, wherein the first metal layer and the second metal layer each contain at least one selected from the group consisting of copper, nickel, and gold.

5. The graphite composite according to claim 1, wherein the anisotropic graphite laminate has a thickness of 0.30 mm to 5.0 mm in the Z axis direction.

6. The graphite composite according to claim 1, wherein the first reinforcing layer contains at least one selected from the group consisting of resin, metal, and ceramic.

7. The graphite composite according to claim 1, further comprising a second reinforcing layer provided on a second of the two surfaces of the anisotropic graphite laminate that is parallel to the Y-Z plane.

8. The graphite composite according to claim 7, wherein a fifth metal layer is provided on the first reinforcing layer and a sixth metal layer is provided on the second reinforcing layer.

9. The graphite composite according to claim 1, wherein a third metal layer and a fourth metal layer are respectively provided on one and the other of the two surfaces of the anisotropic graphite laminate that are parallel to the X-Z plane.

10. The graphite composite according to claim 9, wherein the third metal layer and the fourth metal layer are in direct contact with the anisotropic graphite laminate.

11. The graphite composite according to claim 1, wherein
the resin layer contains at least either one of thermoplastic resin and thermosetting resin, and
the resin layer has a glass transition temperature of 50° C. or more.

12. A method for producing a graphite composite including an anisotropic graphite laminate in which, given an X axis, a Y axis orthogonal to the X axis, and a Z axis perpendicular to the X-Y plane as three spatial axes orthogonal to each other, two or more graphite sheets are stacked on top of each other, in the Y axis direction, with a resin layer between adjacent graphite sheets, and crystal orientation planes of graphite layers are disposed in parallel to the X-Z plane, wherein the anisotropic graphite laminate has a first principal face parallel to the X-Y plane and a second principal face opposite to the first principal face, the method comprising:
a reinforcing step of forming a reinforcing layer on at least one of two surfaces of the anisotropic graphite laminate that are parallel to the Y-Z plane;
a metal layer formation step of forming a first metal layer and a second metal layer respectively on the first principal face and second principal face of the anisotropic graphite laminate with the reinforcing layer formed thereon; and
a cutting step of cutting the reinforcing layer and the anisotropic graphite laminate after the reinforcing step and before the metal layer formation step, wherein
the first metal layer and the second metal layer each have a thickness of 2 μm to 50 μm.

13. (canceled)

14. The method for producing a graphite composite according to claim 12, wherein the first metal layer and the second metal layer are simultaneously formed in the metal layer formation step.

15. The method for producing a graphite composite according to claim 12, wherein
the resin layer contains at least either one of thermoplastic resin and thermosetting resin, and
the resin layer has a glass transition temperature of 50° C. or more.
